(19) United States
(12) Patent Application Publication
(10) Pub. No.: US 2026/0288307 A1
(43) Pub. Date: Sep. 24, 2026

(54) AUDIO OUTPUT APPARATUS AND CONTROL METHOD THEREOF

(71) Applicant: SAMSUNG ELECTRONICS CO., LTD., Suwon-si (KR)

(72) Inventors: Dajeong SIM, Suwon-si (KR); Soohyun Whang, Suwon-si (KR); Jinsu Park, Suwon-si (KR)

(73) Assignee: SAMSUNG ELECTRONICS CO., LTD., Suwon-si (KR)

(21) Appl. No.: 19/639,873

(22) Filed: Apr. 6, 2026

Related U.S. Application Data
(63) Continuation of application No. PCT/KR2026/002674, filed on Feb. 12, 2026.

(30) Foreign Application Priority Data
Mar. 19, 2025 (KR) 10-2025-0035294

(51) Int. Cl. G06F 3/0482; G06F 3/04842; G06F 3/04883

(52) U.S. Cl. CPC G06F 3/0482; G06F 3/04842; G06F 3/04883

(57) ABSTRACT

An audio output apparatus includes memory storing instructions; a display; and at least one processor including processing circuitry, wherein the instructions, when executed by the at least one processor individually or collectively, cause the audio output apparatus to: control, based on a background user interface (UI) indicating a state of replaying contents being displayed, display a plurality of first UIs along a plurality of arcs that divide the background UI into a plurality of track regions; and control, based on a user manipulation for selecting an item of a plurality of items included in the contents, the display to change a first UI corresponding to the item among the plurality of displayed first UIs to a second UI corresponding to the item, and display the second UI.

### CROSS-REFERENCE TO RELATED APPLICATIONS

This application is a continuation of International Application No. PCT/KR2026/002674, filed on Feb. 12, 2026, which is based on and claims priority to Korean Patent Application No. 10-2025-0035294, filed on Mar. 19, 2025, in the Korean Intellectual Property Office, the disclosures of which are incorporated by reference herein in their entireties.

### BACKGROUND

### 1. Field

This disclosure relates to an audio output apparatus, and a control method thereof, and more particularly, to an audio output apparatus displaying a plurality of replayable items along a plurality of arcs and displaying a selected item among the plurality of items through a user interface (UI), and a control method thereof.

### 2. Description of Related Art

With the advancement in electronic technologies, more and more electronic apparatuses display, on a screen, a list of a plurality of items and contents. The electronic apparatuses allow users to select one of the plurality of listed items and use the contents.

In particular, electronic apparatuses that display a UI together in association with contents such as music being replayed have been recently developed. As one example, an album art such as an album image included in a LP or a CD may be displayed on a screen together with a replay state of music.

### SUMMARY

According to an aspect of the disclosure, an audio output apparatus includes: memory storing instructions; a display; and at least one processor including processing circuitry, wherein the instructions, when executed by the at least one processor individually or collectively, cause the audio output apparatus to: control, based on a background user interface (UI) indicating a state of replaying contents being displayed, display a plurality of first UIs along a plurality of arcs that divide the background UI into a plurality of track regions; and control, based on a user manipulation for selecting an item of a plurality of items included in the contents, the display to change a first UI corresponding to the item among the plurality of displayed first UIs to a second UI corresponding to the item, and display the second UI.

The plurality of arcs may be spaced apart from each other by a predetermined gap based on a number of the plurality of items and a size of the background UI.

The instructions, when executed by the at least one processor individually or collectively, may cause the audio output apparatus to: control the display to display the plurality of first UIs along the plurality of arcs based on a first user manipulation for activating the plurality of first UIs; and control the display to change the first UI to the second UI and display the second UI based on a second user manipulation for selecting the item of the plurality of items.

The instructions, when executed by the at least one processor individually or collectively, may cause the audio output apparatus to: inactivate, based on a user manipulation for selecting a second item different from a first item selected previously among the plurality of items, the second UI corresponding to the first item; and control the display to change a first UI corresponding to the second item along an arc corresponding to the second item among the plurality of arcs to a second UI corresponding to the second item and display the second UI.

The instructions, when executed by the at least one processor individually or collectively, may cause the audio output apparatus to: control the display to change at least one first UI corresponding to at least one third item between the second item and the first item respectively to at least one second UI corresponding to the at least one third item and display the at least one second UI sequentially; and control the display to change the first UI corresponding to the second item to the second UI corresponding to the second item and display the second UI.

The instructions, when executed by the at least one processor individually or collectively, may cause the audio output apparatus to: control the display to change the first UI to the second UI and display the second UI, based on a user manipulation for selecting the item to be replayable at the audio output apparatus; and control the display to display a screen in which the background UI updated based on the item is rotated with respect to a center point of the background UI.

The instructions, when executed by the at least one processor individually or collectively, may cause the audio output apparatus to control the display to inactivate the second UI, as predetermined time passes after the second UI is displayed, and display the screen in which the updated background UI is rotated.

The audio output apparatus may further include a tonearm rotatable with respect to an axis placed outside the display, the display may be a circular display, and the instructions, when executed by the at least one processor individually or collectively, may cause the audio output apparatus to: control, based on a circular background UI being displayed in a state in which the tonearm is placed at an initial position, the circular display to display the plurality of first UIs; and control the display to change the first UI to the second UI and display the second UI, based on the user manipulation for selecting the item of the plurality of items corresponding respectively to a plurality of positions to which the tonearm is capable of being moved.

The audio output apparatus may further include: a driving apparatus configured to rotate the tonearm, and the instructions, when executed by the at least one processor individually or collectively, may cause the audio output apparatus to: control the driving apparatus to move the tonearm to a position corresponding to the item among the plurality of positions, based on the user manipulation; and control the circular display to change the first UI to the second UI and display the second UI in a state in which the tonearm is moved to the position.

The audio output apparatus may further include: a sensor configured to sense rotation of the tonearm, and the instructions, when executed by the at least one processor individually or collectively, may cause the audio output apparatus to: identify, as the item, an item of a position to which the tonearm is moved among the plurality of items, based on sensing data obtained by sensing the rotation of the tonearm, wherein the rotation of the tonearm is sensed based on the user manipulation through the sensor; and control the circular display to change the first UI corresponding to the item to the second UI and display the second UI.

According to an aspect of the disclosure, a control method of an audio output apparatus, includes: displaying, based on a background user interface (UI) indicating a state of replaying contents being displayed by a display of the audio output apparatus, a plurality of first UIs along a plurality of arcs that divides the background UI into a plurality of track regions; and changing, based on a user manipulation selecting an item of a plurality of items included in the contents, a first UI corresponding to the item among the plurality of displayed first UIs to a second UI corresponding to the item, and displaying the second UI.

The plurality of arcs may be spaced apart from each other by a predetermined gap based on a number of the plurality of items and a size of the background UI.

The displaying the plurality of first UIs may include displaying the plurality of first UIs along the plurality of arcs based on a first user manipulation for activating the plurality of first UIs, and the changing a first UI to a second UI and the displaying the second UI may include changing the first UI to the second UI and displaying the second UI based on a second user manipulation for selecting the item of the plurality of items.

The changing the first UI to the second UI and displaying the second UI may include: inactivating, based on the user manipulation for selecting a second item different from a first item selected previously among the plurality of items, the second UI corresponding to the first item; and changing a first UI corresponding to the second item along an arc corresponding to the second item among the plurality of arcs to a second UI corresponding to the second item and displaying the second UI.

The changing the first UI corresponding to the second item along the arc corresponding to the second item among the plurality of arcs to the second UI corresponding to the second item and the displaying the second UI may include: changing at least one first UI corresponding to at least one third item between the second item and the first item respectively to at least one second UI corresponding to the at least one third item and displaying the at least one second UI sequentially; and changing the first UI corresponding to the second item to the second UI corresponding to the second item and displaying the second UI.

The changing the first UI corresponding to the selected item to the second UI corresponding to the selected item and displaying the second UI may include changing the first UI to the second UI and displaying the second UI, based on a user manipulation for selecting the item to be replayable at the audio output apparatus, and the method may further include displaying a screen in which the background UI updated based on the item is rotated with respect to a center point of the background UI.

The displaying the screen in which the updated background UI is rotated with respect to the center point of the background UI may include inactivating the second UI, as predetermined time passes after the second UI is displayed, and displaying the screen in which the updated background UI is rotated.

The display may be a circular display, the displaying the plurality of first UIs may include controlling, based on a circular background UI being displayed in a state in which a tonearm rotatable with respect to an axis placed outside the circular display at the audio output apparatus is placed at an initial position, the circular display to display the plurality of first UIs, and the displaying the first UI corresponding to the item to the second UI corresponding to the item and displaying the second UI may include controlling the circular display to change the first UI to the second UI and display the second UI, based on the user manipulation for selecting the item of the plurality of items corresponding respectively to a plurality of positions to which the tonearm is capable of being moved.

The controlling the circular display to change the first UI to the second UI and display the second UI may include: controlling a driving apparatus of the audio output apparatus to move the tonearm to a position corresponding to the item among the plurality of positions, based on the user manipulation; and controlling the circular display to change the first UI to the second UI and display the second UI in a state where the tonearm is moved to the position.

According to an aspect of the disclosure, a non-transitory computer-readable recording medium stores instructions that, when executed by at least one processor of an audio output apparatus, collectively or individually, may cause the audio output apparatus to perform operations including: generating a screen in which a plurality of first user interfaces (UIs) is displayed along a plurality of arcs that divide a background UI indicating a state of replaying contents into a plurality of track regions; and generating, based on a user manipulation for selecting an item of a plurality of items included in the contents, a screen in which a first UI corresponding to the item among the plurality of displayed first UIs is changed to a second UI corresponding to the item.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view of an audio output apparatus schematically according to one or more embodiments;

FIG. 2 is a block diagram illustrating a configuration of an audio output apparatus according to one or more embodiments;

FIG. 3 is a block diagram illustrating a configuration of an audio output apparatus according to one or more embodiments;

FIG. 4 is a view of an audio output apparatus according to one or more embodiments;

FIG. 5 is a view of a first UI according to one or more embodiments;

FIG. 6 is a view illustrating user manipulation of a UI according to one or more embodiments;

FIG. 7 is a view illustrating a tonearm according to one or more embodiments;

FIG. 8 is a view illustrating a second UI according to one or more embodiments;

FIG. 9 is a flowchart of an operation process of an audio output apparatus according to one or more embodiments; and

FIG. 10 is a flowchart of an operation process of selecting and replaying a track according to one or more embodiments.

### DETAILED DESCRIPTION

Embodiments of the present disclosure may be modified in various different forms, and may vary. Accordingly, specific embodiments are illustrated in the drawings, and described in detail in the detailed description. However, it is to be understood that the scope of the disclosure is not limited to the specific ones, and embodiments of the disclosure are to be understood as including various modifications, equivalents and/or alternatives of the embodiments set forth herein. In the drawings, like reference numerals may be used to indicate like elements.

In describing the disclosure, in case specific descriptions of known functions or configurations to which the disclosure pertains make the gist of the disclosure unnecessarily vague, detailed descriptions thereof are omitted.

Additionally, the embodiments described hereafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms set forth herein are merely used to describe a specific embodiment, and are not intended to limit the scope of the right for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, expressions such as “A or B,” “at least one of A or/and B,” or “one or more of A or/and B” and the like may include all possible combinations of items listed together. For example, “A or B,” “at least one of A and B,” or “at least one of A or B” may refer to all cases including (1) A, (2) B, or (3) both A and B.

In the disclosure, the expression “1st”, “2nd”, “first”, or “second”, and the like may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

In the disclosure, the expression “configured to . . . (or set to)” used in the disclosure may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to . . . (or set to)” may not necessarily mean “specifically designed to . . . ” in terms of hardware.

Rather, in a certain situation, the expression “an apparatus configured to . . . ” may mean “being capable of performing” by the apparatus together with another apparatus or other components. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory apparatus.

In relation to the embodiments, the term “module” or “unit” may perform at least one function or operation, and be implemented by hardware or software or by a combination of hardware and software. Additionally, a plurality of “modules” or a plurality of “units” may be integrated into at least one module and be implemented as a processor except for a “module” or a “unit” that needs to be implemented by specific hardware.

Various elements and regions in the drawings are schematically illustrated. Accordingly, the technical spirit of the disclosure is not limited by relative sizes or distances illustrated in the accompanying drawings.

Hereafter, the subject matter of the disclosure is described in detail with reference to the accompanying drawings such that those skilled in the art to which the disclosure pertains readily implements the embodiments according to the disclosure.

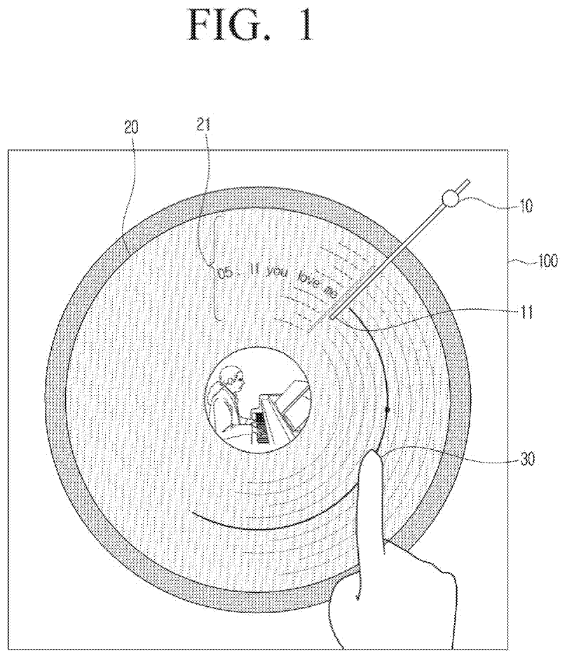

FIG. 1 is a view provided to explain an operation of an audio output apparatus schematically according to one or more embodiments.

Referring to FIG. 1, an audio output apparatus 100 is illustrated.

The audio output apparatus 100 may output an audio signal. The audio output apparatus 100 may output audio contents received from an external apparatus or audio contents stored in an internal storage medium, and the like. The audio output apparatus 100 may be alternatively referred to as a replaying apparatus, or an audio processing apparatus.

The audio output apparatus 100 may be implemented as an apparatus capable of replaying a video and an audio together as well as audio contents.

In other words, the audio output apparatus 100 may be implemented as an apparatus provided with a display for displaying an image. For example, the audio output apparatus 100 may display a replay state and the like of audio contents that are being output.

In this case, the audio output apparatus 100 may be implemented as an apparatus such as a mobile phone, a smartphone and the like, but not limited thereto, and may also be implemented as various types of audio output apparatuses provided with a display such as a TV, a monitor, a laptop PC, a tablet PC, a video wall, a large format display (LFD), a digital signage, a Digital Information Display (DID), a projector display, a kiosk, a digital whiteboard, a refrigerator, an air conditioner and the like. Additionally, the audio output apparatus 100 may also be implemented as various types of audio output apparatuses such as a set-top box, a PC, a home server or the like that is connected with an external audio output apparatus (e.g., a TV or a monitor and the like), for use, without being provided with a display directly.

Alternatively, the audio output apparatus 100 may be implemented not only as various types of independent apparatuses like the above-described apparatuses but also in the form of a display panel or a module applicable to the independent apparatuses.

The audio output apparatus 100 may output a user interface (UI) 20 through a screen. In embodiments, the UI 20 may correspond to a graphic element output through a screen of the audio output apparatus 100. The UI may be implemented in various shapes (e.g., a triangle, a rectangle, a rhombus, a triangle and the like), depending on the shape of the screen of the audio output apparatus 100.

For example, in the case where the screen of the audio output apparatus 100 is implemented in a circle shape (including an oval shape), the UI 20 may be implemented in a circle shape.

In the case where the UI 20 is implemented in the form of a circle concentric to the circle of the screen as described above, the UI 20 may include an image in the form of a concentric circle of which a size is less than the size of the circle of the UI 20. In this disclosure, the image may correspond to a representative image of contents corresponding to the UI 20.

In this disclosure, the contents corresponding to the UI 20 may mean contents displayed by the UI 20. For example, in the case of a content as a record album including a plurality of contained tracks, the UI 20 may include a cover image (or an album art) of the record album. However, this is described merely as one example, and the image included in the UI 20 may be implemented in various forms, and depending on the type of content, may be implemented in various forms.

For example, the UI 20 may include an image of a record. In this disclosure, the record may mean an individual record contained in an album. In this case, the UI 20 may include an image indicating an individual record included in an album. In this disclosure, the image indicating the individual record may correspond to an image separately designed to display the individual record.

Alternatively, the image indicating the individual record may include a form of the individual record. For example, an actual form of the individual record may mean an actual type such as a LP in the album, a CD, a cassette tape and the like. However, the type of individual record is not limited thereto.

The UI 20 may include a plurality of items 21. The audio output apparatus 100 may display a selected item, based on an external input for selecting one of the plurality of items 21 displayed. For example, the audio output apparatus 100 may newly update a portion corresponding to an item selected at the UI 20.

In this disclosure, newly updating may mean that the audio output apparatus 100 displays the portion corresponding to the item selected at the UI 20 in bold (or in a thick line), to differentiate the portion from the remainders among the plurality of items 21. However, newly updating is not limited thereto.

The above-described external input may correspond to a user manipulation input. In this disclosure, the user manipulation input may mean an input based on a user manipulation aiming for manipulating the audio output apparatus 100.

In this disclosure, the user manipulation input may mean an input based on a touch input 30 of the user or an input through a tonearm 10.

The touch input 30 of the user may correspond to a manipulation input for selecting one of the plurality of items 21. The user may touch the screen to select one (e.g., 05. If you love me) of a plurality of items 21. For example, in the case where the screen of the audio output apparatus 100 is implemented as a screen provided with a touch sensor, the audio output apparatus 100 may detect the touch input 30 of the user.

The user may select one of the plurality of items 21 through the tonearm 10. The tonearm 10 may mean a structure in the form of a bar on which a cartridge is mounted, on a LP turntable. As the tonearm 10 actually moves (rotates) along a groove of a record being rotated on an actual LP turntable, a needle (a stylus) may extract a signal.

In this disclosure, the stylus may correspond to a small-sized component formed into a needle that extracts an audio signal mechanically while moving along a groove of the LP record.

As illustrated in FIG. 1, the audio output apparatus 100 may be provided with a tonearm 10 even in the case where a LP-shaped UI 20 is displayed, unlike an actual turntable. In this case, the size of the tonearm 10 may be determined based on the size of the screen or the size of the UI 20.

However, unlike a tonearm used for an actual turntable, the tonearm 10 may include an end portion 11 instead of a stylus. In this disclosure, the end portion 11 may mean a portion corresponding to a stylus of an actual turntable. In other words, the end portion 11 may correspond to a portion that is placed at one selected among the plurality of items 21 and indicates a replay state, like the stylus extracting an audio signal while moving along the groove of a selected track of a LP record on an actual turntable.

For example, the user may manipulate the tonearm 10 in the way of rotating the tonearm 10 to select one (e.g., 05. If you love me) of the plurality of items 21. As the tonearm 10 is rotated based on the user manipulation, the end portion 11 may be placed in one portion selected among the plurality of items 21.

The audio output apparatus 100 may identify, based on the end portion 11 recognized as being placed in one portion of the plurality of items 21, that an item of the portion where the end portion 11 is placed is selected.

In the case where one of the plurality of items 21 is selected based on a user manipulation input as described above, the audio output apparatus 100 may display a replay state. In other words, the audio output apparatus 100 may display the state (e.g., a replay state) of the selected item in a thick line. In this case, the audio output apparatus 100 may display the UI 20 in the way that a background UI (a portion excluding the portion where the plurality of items is displayed) is rotated out of the UI 20.

As described above, the audio output apparatus 100 may display a plurality of items of contents through the UI 20 shaped into a LP record, and as one of the plurality of items 21 is selected, may display a replay state and the like. Additionally, the audio output apparatus 100 may identify that one of the plurality of items 21 is selected based on an input (e.g., a touch input) using the living body of the user or an input through a button (e.g., a tonearm 10).

However, selecting one of the plurality of items is not limited thereto, and the audio output apparatus 100 is not limited thereto, and the audio output apparatus 100 may receive an input based on a gesture interaction or an input through a remote controller and the like.

In this disclosure, the gesture interaction may mean an input method of interacting with the audio output apparatus 100 by detecting a motion of a living body (a finger, a hand, a head and the like). For example, the audio output apparatus 100 may detect a motion of a living body directly, or detect a motion of a living body through an external apparatus. In this disclosure, the motion of the living body may correspond to a motion for selecting one of the plurality of items 21.

The audio output apparatus 100 may receive a button input of an external apparatus such as a remote controller. For example, in the case where a button manipulation for selecting a specific item is input to a remote controller, the remote controller may transmit a remote controller signal corresponding to the manipulation to the audio output apparatus 100. The audio output apparatus 100 may identify that the specific item is selected based on the received remote controller signal.

The audio output apparatus 100 may identify that the specific item is selected based on various input methods, in addition to the above-described method. For example, the audio output apparatus 100 may receive an input for selecting a specific item based on a voice input (e.g., a voice instruction), an electronic pen (e.g., a stylus pen) and the like.

By doing so, the user may gain an experience in which the user feels like the user uses a turntable actually, through a digital LP. In this disclosure, the digital LP may mean a virtual LP displayed on a screen through the UI 20. In this disclosure, the LP may be referred to as various terms such as a vinyl, a LP record and the like. However, in the disclosure, the digital LP is referred to as a “LP” for convenience of description.

In other words, the audio output apparatus 100 may display a replay state of a sound source trough the digital LP, and receive an input of a digital LP-based user manipulation, such that the user may gain a user experience in which the user feels like the user owns an actual LP.

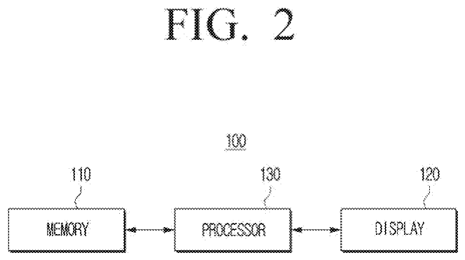

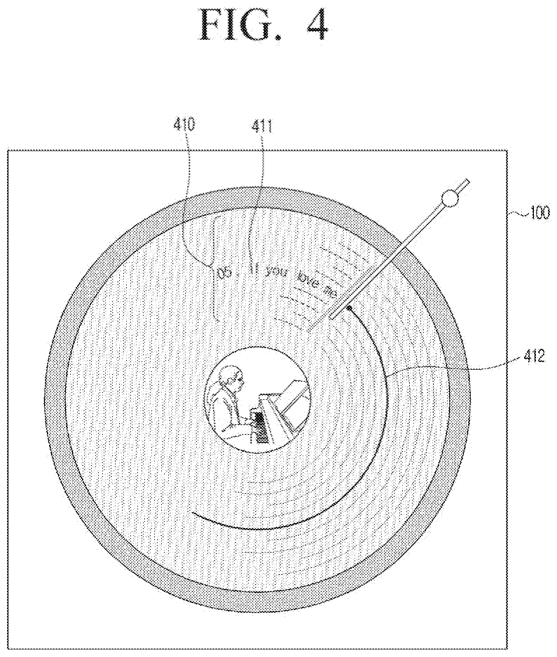

Specific operation steps in which the audio output apparatus 100, as described above, displays a plurality of items and displays one of the plurality of items are described in detail hereafter with reference to FIGS. 2 and 4.

FIG. 2 is a block diagram provided to explain a configuration of an audio output apparatus according to one or more embodiments.

Referring to FIG. 2, an audio output apparatus 100 may include memory 110, a display 120 and at least one processor 130.

The memory 110 may be operatively connected with the at least one processor 130, and store data required for the embodiments of the disclosure. For example, the memory 110 may be implemented in the form of internal memory such as Read-Only Memory (ROM) (e.g., electrically erasable programmable read-only memory (EEPROM)), Random Access Memory (RAM), and the like) included in the at least one processor 130, or in the form of memory separate from the at least one processor 130.

The memory 110 may be implemented as memory embedded in the audio output apparatus 100, or as memory detachable from the audio output apparatus 100 depending on a data storage purpose. For example, in the case of data for driving the audio output apparatus 100, the data may be stored in the memory embedded in the audio output apparatus 100, and in the case of data for an expansion function of the audio output apparatus 100, the data may be stored in memory detachable from the audio output apparatus 100. In the case where the memory 110 is implemented as memory embedded in the audio output apparatus 100, the memory 110 may be at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)).

In the illustrative example, the audio output apparatus 100 comprised of one memory is illustrated, but in the case where the volatile memory and non-volatile memory are referred to in a differentiated manner, the audio output apparatus 100 may also be referred to as including a plurality of memories.

The memory 110 according to one or more embodiments may include at least one instruction. In this disclosure, the at least one instruction may correspond to at least one instruction for the audio output apparatus 100 to change a first UI to a second UI corresponding to a selected item and display the second UI. In this disclosure, the first UI and the second UI are respectively described in detail hereafter.

The memory 110 may store information required for an operation of the audio output apparatus 100 in addition to the at least one instruction.

The audio output apparatus 100 may include a display 120.

The display 120 is an element for displaying an operation state or a notification message of the audio output apparatus 100, a UI screen and the like. The display may be implemented as various types of displays such as a liquid crystal display (LCD), an organic light emitting diode (OLED) display, a plasma display panel (PDP), and the like. In the display, driving circuitry implementable in the form of an amorphous silicon thin film transistor (a-si TFT), a low temperature poly silicon (LTPS) TFT, an organic TFT (OTFT) and the like, a backlight unit, and the like may be included together. The display may be implemented as a touch screen coupled with a touch sensor, a flexible display, a three-dimensional (3D) display, and the like. Alternatively, the display may be also implemented only as one light-emitting element or a plurality of light-emitting elements.

Depending on various states such as a state where the audio output apparatus 100 is turned on, a state where the audio output apparatus 100 is operating normally, a state where the audio output apparatus 100 is short of electric power or a state where the audio output apparatus 100 is in an error state, and the like, the audio output apparatus 100 may change a display state of the display such that the user intuitively knows the state of the audio output apparatus 100.

For example, the audio output apparatus 100 may display various graphic elements such as a UI and the like required for the audio output apparatus 100 to change the first UI to the second UI and display the second UI. In this disclosure, the first UI may correspond to a UI that may be displayed along a plurality of arcs of the background UI. The first UI, the second UI and the background UI and the like are described in detail hereafter.

The at least one processor 130 may perform an entire control operation of the audio output apparatus 100.

The at least one processor 130 may be implemented as a digital signal processor (DSP) processing a digital signal, a microprocessor, a time controller (TCON). However, the processor is not limited thereto, and may include one or more of a central processing unit (CPU), a micro controller unit (MCU), a micro processing unit (MPU), a controller, an application processor (AP), a graphics-processing unit (GPU) or a communication processor (CP), an ARM processor, or may be defined as such terms. Additionally, the at least one processor 130 may be implemented in the form of a system on a chip (SoC) with an embedded processing algorithm, large scale integration (LSI), or a field programmable gate array (FPGA). Further, the at least one processor 130 may perform various functions by executing computer executable instructions stored in the memory. In FIG. 2, the audio output apparatus 100 including one processor is illustrated, but when implemented, the audio output apparatus 100 may include a plurality of processors (e.g., CPU+GPU, CPU+DSP).

The instructions stored in the above-described memory 110, when executed by the at least one processor 130 individually or collectively, may cause the audio output apparatus 100 to perform the operations described hereafter.

According to one or more embodiments, as the background UI is displayed, the audio output apparatus 100 may control the display 120 to display a plurality of first UIs along a plurality of arcs.

In this disclosure, the background user interface (UI) may mean a UI indicating a state of replaying contents. For example, the background UI may be implemented as a circle-shaped UI (e.g., a LP-shaped UI).

The background UI may include a representative image (e.g., an album cover image) of contents. Additionally, the background UI may correspond to a background for displaying a plurality of items (e.g., contained tracks) included in the contents.

As the background UI is displayed, the audio output apparatus 100 may display the plurality of first UIs along a plurality of arcs. In this disclosure, the plurality of arcs may correspond to arcs dividing the background UI into a plurality of track regions.

In this disclosure, the plurality of track regions may mean a number of regions that are divided in the entire shape (e.g., a circle, an oval and the like) of the background UI. In this disclosure, each of the plurality of divided regions may have a track (or ring) shape.

In this disclosure, the track shape may mean the shape of a curved path divided with respect to a specific center (a center of the background UI). Each of the plurality of track regions having a track shape may be set to have a specific width.

The audio output apparatus 100 may display the plurality of first UIs along the plurality of arcs. In this disclosure, the first UIs may mean a UI including information of a plurality of items included in the contents (e.g., a plurality of tracks included in an album). For example, the first UIs may include the number, artist, replay time and the like of a corresponding contained track.

The audio output apparatus 100 displaying the plurality of first UIs along the plurality of arcs may mean displaying the first UI elements in the way that the first UIs are arranged and displayed in accordance with the shape and curvature of the plurality of arcs.

For example, the audio output apparatus 100 may arrange and display the plurality of first UIs such that the plurality of first UIs is placed at the plurality of arcs respectively along the plurality of arcs. Alternatively, the audio output apparatus 100 may arrange and display the plurality of UIs in accordance with the curvature of the plurality of arcs even in the case where the plurality of UIs is not placed at the plurality of arcs.

The audio output apparatus 100 may display the plurality of first UIs corresponding to the plurality of items respectively on the background UI in a specific order. In this disclosure, the order of arranging the plurality of first UIs may be set based on the order of the plurality of items stored in the contents.

In other words, in the case where the plurality of items is included the contents in a specific order, the audio output apparatus 100 may display the plurality of first UIs based on the order. However, the order of the plurality of first UIs is not limited thereto, and the plurality of first UIs may be displayed in various orders based on replay time, a reply frequency or other user settings and the like.

The audio output apparatus 100 may display the plurality of above-described arcs with a specific gap.

According to one embodiment, the audio output apparatus 100 may control the display 120 to display the plurality of first UIs along the plurality of arcs placed with a predetermined gap. In this disclosure, the predetermined gap may correspond to a gap determined based on the number of the plurality of items and the size of the background UI.

For example, a gap of the plurality of arcs may be set uniformly. In detail, the gap of the plurality of arcs may be set to a value calculated by dividing the range of an available region from the background UI by the number of the plurality of items.

In this disclosure, the available region may mean a region excluding a region of the background UI, where a representative image of the contents is displayed. In this disclosure, the available region may include the plurality of track regions described above. The representative image is descried above in detail with reference to FIG. 1, and accordingly, repetitive descriptions thereof are omitted.

Meanwhile, in the case where the number of the plurality of items exceeds a reference number, the gap may be determined based on the reference number rather than the number of the plurality of items. In this disclosure, the reference number may mean a maximum number of items displayable on the background UI.

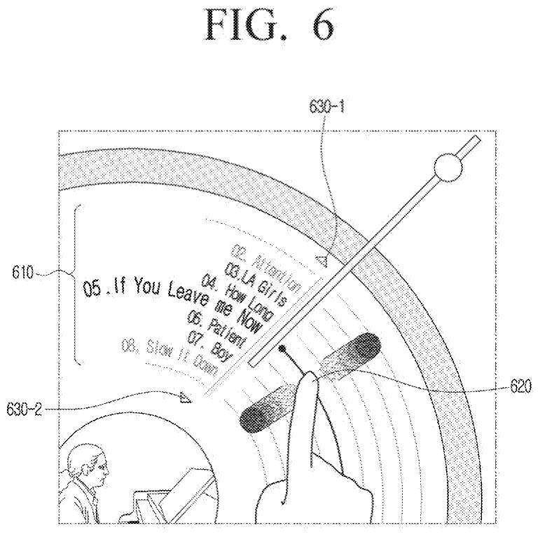

In other words, the number of the plurality of items included in the contents exceeds a specific number, the audio output apparatus 100 may display an additional UI indicating the presence of remaining items while items are displayed as many as the background UI can display. Detailed descriptions in relation to this are provided hereafter with reference to FIG. 6.

The gap of the plurality of arcs may be set based on a duration corresponding to each of the items. For example, in the case where a plurality of tracks is included in contents such as a record album, the replay time of each of the tracks (contained tracks) may differ. In this case, the gap of the plurality of arcs may be set in proportion to the replay time of each of the tracks.

In detail, a gap corresponding to a track of a long replay time may be set to be long, while a gap corresponding to a track of a relatively short replay time may be set to be relatively short. In this disclosure, a gap corresponding to each of the tracks may mean a width of a track region where a UI (first UI) corresponding to each of the tracks is displayed.

The gap of the plurality of arcs may correspond to a gap predetermined based on the above-descried method, but may be described merely as an example, and the gap of the plurality of arcs may be determined in various ways.

Meanwhile, in the case where the background UI is implemented as the above-described digital LP, the plurality of arcs described above may indicate a thick line that is the boundary of a track on an actual LP. In the case of an actual LP, the stylus may extract an audio signal through grooves (sound grooves or grooves) of a region between two thick lines.

As described above, audio information of a specific track may be recorded in a region between thick lines on an actual LP through the grooves. In other words, the region between the thick lines on the actual LP may mean a region where a specific track is stored.

The audio output apparatus 100 may display information of a contained track along an arc set with a specific gap by reflecting a physical attribute implemented on the actual LP. By doing so, the audio output apparatus 100 may provide, to the user, a user experience similar to an experience in which the user owns and uses an actual LP record.

According to one or more embodiments, the audio output apparatus 100 may control the display 120 to change one of the plurality of first UIs displayed based on a user manipulation to a second UI and display the second UI.

In this disclosure, the user manipulation may mean a manipulation for selecting one of a plurality of items included in contents. The user manipulation is described above in detail with reference to FIG. 1, and accordingly, repetitive descriptions thereof are omitted.

The audio output apparatus 100 may change one of the plurality of first UIs to a second UI and display the second UI based on a user manipulation. In this disclosure, one of the plurality of first UIs may correspond to a first UI corresponding to one item selected among the plurality of items, among the plurality of first UIs. Additionally, the second UI may correspond to a second UI corresponding to the selected item.

In this disclosure, the second UI may mean a UI indicating the state where a specific item is selected. For example, in the case where one of the plurality of items is selected, the second UI may indicate the state where the selected item is selected and is being replayed.

Specifically, in the case where a specific one of contained tracks included in a record album is selected, the second UI may include information on a total replay time of the contained track and a current replay position and the like. Detailed descriptions in relation to this are provided hereafter with reference to FIG. 4.

The audio output apparatus 100 may change a first UI corresponding to the selected item to a second UI corresponding to the selected item and display the second UI. In this disclosure, the first UI corresponding to the selected item may include the number and the title and the like of the selected item among the plurality of first UIs.

Additionally, the second UI corresponding to the selected item may include information on the replay state (e.g., replay time (length), a current replay position and the like) of the selected item among a plurality of second IUs. In this disclosure, the plurality of second UIs may correspond to a plurality of second UIs with respect to the plurality of items. For example, each of the plurality of second UIs may include the replay time and the like of a corresponding track among a plurality of contained tracks.

Meanwhile, changing a first UI to a second UI and displaying the second UI may mean that the audio output apparatus 100 updates a first UI corresponding to a selected item to a second UI and displays the second UI. In this disclosure, the second UI may mean a second UI corresponding to the selected item.

For example, as a specific item is selected (based on a user manipulation) in the state where a plurality of items is displayed through a plurality of first UIs, the audio output apparatus 100 may display a second UI corresponding to the selected item rather than a first UI corresponding to the selected item.

In this case, the audio output apparatus 100 may display a plurality of remaining first UIs and second UIs. In this disclosure, the plurality of remaining first UIs may mean remaining UIs excluding the first UI corresponding to the selected item among the first UIs corresponding to the plurality of items respectively.

Meanwhile, displaying the second UI rather than the first UI may mean that the second UI is displayed at a position where the first UI corresponding to the selected item is displayed. However, displaying the second UI is not limited thereto, and the second UI may be displayed in a range within a specific range from the first UI corresponding to the selected item.

For example, in the case where the first UI is displayed in a specific track region among a plurality of track regions, the second UI may be displayed at a position different from the position where the first UI is displayed within the track region.

The audio output apparatus 100 may activate the plurality of first UIs based on a specific user input.

According to one embodiment, the audio output apparatus 100 may control the display 120 to display a plurality of first UIs along a plurality of arcs based on a first user manipulation. In this disclosure, the first user manipulation may correspond to a user manipulation for activating the plurality of first UIs.

In detail, the first user manipulation, as a manipulation different from a second user manipulation described hereafter, may correspond to a manipulation for displaying a plurality of selectable items by activating the plurality of first UIs. In this disclosure, activating the plurality of first UIs may mean that the audio output apparatus 100 displays the first UIs in the state where the first UIs are not displayed (i.e., a state where a background UI is only displayed).

The audio output apparatus 100 may receive an input of the first user manipulation through various types of interfaces such as a touch display or a button and the like.

For example, in the case where the audio output apparatus 100 receives an input of a first user manipulation through a touch display, the first user manipulation may correspond to a manipulation of a tab (or a hard tab and the like) of the display 120. In this disclosure, the hard tab, unlike an ordinary tab, may mean a touch method by which the touch display is pressed with high pressure or for a sustained period.

In the case where the audio output apparatus 100 receives an input of a first user manipulation through a button (e.g., a tonearm), the first user manipulation may correspond to a manipulation of rotating the button at a specific angle or pressing the button for a sustained period and the like. However, the first user manipulation is not limited thereto.

The audio output apparatus 100 may receive an input caused by the first user manipulation in an initial state. In this disclosure, the initial state may mean a state where a specific item included in contents is not being replayed.

For example, after activating specific contents, the audio output apparatus 100 may display a background UI. In this disclosure, activating specific contents may mean that an item included in the specific contents is completely ready to be replayed. The audio output apparatus 100 may receive an input of a first user manipulation in the state where the background UI is displayed.

In detail, activating specific contents may mean that the audio output apparatus 100 is completely ready to replay at least one of a plurality of items, based on a user manipulation for selecting one of a plurality of replayable contents. As the specific contents are activated, the audio output apparatus 100 may display a background UI corresponding to the contents.

The audio output apparatus 100 may receive an input of a first user manipulation in a replay state. In this disclosure, the replay state may mean a state where another item among the plurality of items is being replayed.

For example, in the case where one of a plurality of items included in contents is selected and being replayed, the audio output apparatus 100 may receive an input of a first user manipulation. In this disclosure, the first user manipulation may mean a manipulation of activating the plurality of first UIs, to select an item different from the item that is already being replayed.

In the case where an item different from the item that is already being replayed is selected after the plurality of first UIs is activated based on the first user manipulation, the audio output apparatus 100 may inactivate the second UI corresponding to the item that is already being replayed. Detailed descriptions in relation to this are provided hereafter.

Meanwhile, as the plurality of first UIs is activated based on the first user manipulation, the audio output apparatus 200 may control the display 120 to change a first UI to a second UI and display the second UI based on a second user manipulation. In this disclosure, the second user manipulation may correspond to a manipulation for selecting one of a plurality of items.

The audio output apparatus 100 may receive an input of the second user manipulation through various types of interfaces such as a touch display or a button and the like, as the audio output apparatus 100 receives an input of the first user manipulation. However, even in the case where the second user manipulation is input through the same interface as the first user manipulation, the second user manipulation may differ from the first user manipulation.

For example, in the case where the first user manipulation is a tab manipulation, the second user manipulation may correspond to a hard tab manipulation. Additionally, in the case where the first user manipulation is a manipulation of pressing the tonearm, the second user manipulation may correspond to a manipulation of rotating the tonearm.

Meanwhile, after a specific item is selected, the audio output apparatus 100 may receive an input of a user manipulation for selecting a new item different from the item as described above.

According to one embodiment, the audio output apparatus 100 may inactivate a previous second UI corresponding to a first item, based on a user manipulation. In this disclosure, the user manipulation may mean a manipulation for selecting a second item different from the first item that is selected previously among the plurality of items.

For example, in the case where the first item (e.g., a first contained track) is selected and replayed, the audio output apparatus 100 may receive an input of a user manipulation for selecting a second item (a second contained track) different from the first item.

In this case, the audio output apparatus 100 may inactivate a previous second UI corresponding to the first item. In this disclosure, the previous second UI may mean a second UI indicating a replay state of a previously replayed item.

In this disclosure, inactivating a previous second UI may mean that the audio output apparatus 100 removes the previous second UI from the background UI. For example, the audio output apparatus 100 may remove the previous second UI from the position where the previous second UI is displayed, and display a first UI corresponding to the first item instead of the previous second UI.

Then the audio output apparatus 100 may display a second UI different from the previous second UI.

According to one embodiment, the audio output apparatus 100 may control the display 120 to change a first UI to a second UI along an arc corresponding to a second item among a plurality of arcs and display the second UI. In this disclosure, the first UI may mean a first UI corresponding to the second item. The second UI may mean a second UI corresponding to the second item.

For example, after the previous second UI is inactivated, a second UI corresponding to a new item (a second item) may be displayed along an arc corresponding to the second item. In detail, the audio output apparatus 100 may display the second UI at the arc corresponding to the second item or in a plurality of track regions adjacent to the arc. In this disclosure, the plurality of track regions adjacent to the arc may mean two track regions divided by the arc.

Meanwhile, in the case where at least one item is present in a first item and a second item, the audio output apparatus 100 may display a process of selecting the second item from the first item through a UI.

As one example, the audio output apparatus 100 may control the display 120 to change at least one first UI corresponding to at least one third item respectively to at least one second UI and display the at least one second UI sequentially.

In this disclosure, the third item may mean at least one item between the second item and the first item. Additionally, the at least one first UI may mean at least one first UI corresponding to the at least one third item among the plurality of first UIs.

For example, in the case where at least one third item is present between a first item and a second item among a plurality of items, the audio output apparatus 100 may display at least one second UI indicating the at least one third item sequentially.

In detail, in the case where at least one third item is present, the audio output apparatus 100 may display at least one second UI sequentially along at least one arc corresponding to the at least one third item respectively.

In this disclosure, displaying the second UI sequentially may mean that the audio output apparatus 100 displays at least one second UI corresponding to at least one third item respectively, in the order of the at least one third item. At this time, the audio output apparatus 100 may inactivate at least one first item corresponding to the at least one third item respectively and display at least one second item.

For example, in the case where three third items (item A, item, B and item C) are present between a first item and a second item, the audio output apparatus 100 may display a second item corresponding to item A, item B and item C respectively.

In detail, the audio output apparatus 100 may inactivate a first UI corresponding to item A, and display the second item corresponding to item A along an arc corresponding to item A. Then the audio output apparatus 100 may inactivate a first UI corresponding to item B, and display the second item corresponding to item B along an arc corresponding to item B. Then the audio output apparatus 100 may inactivate a first UI corresponding to item C, and display the second item corresponding to item C along an arc corresponding to item C.

Accordingly, in the case where a specific item is present between a first item and a second item, the audio output apparatus 100 may display a process of selecting the second item from the first item visually.

Then the audio output apparatus 100 may control the display 120 to change a first UI corresponding to the second item to a second UI corresponding to the second item and display the second UI.

Meanwhile, as a specific item is selected among a plurality of items, the audio output apparatus 100 may display a UI indicating a replay state of the specific item.

According to one embodiment, the audio output apparatus 100 may control the display to change a first UI to a second UI and display the second UI based on a user manipulation. In this disclosure, the user manipulation may mean a manipulation for selecting one of a plurality of items replayable at the audio output apparatus.

The items replayable at the audio output apparatus 100 may mean items that can be selected by the user and output as contents (an audio, a video, and other multimedia contents) at the audio output apparatus 100. The operation in which the audio output apparatus 100 changes a first UI to a second UI and displays the second UI is described above, and accordingly, repetitive descriptions thereof are omitted.

After displaying the second UI, the audio output apparatus 100 may update the background UI based on the selected item.

According to one embodiment, the audio output apparatus 100 may control the display 120 to display a screen in which the updated background UI is rotated with respect to the center point of the background UI. In this disclosure, the updated background UI may mean a UI updated based on the selected item.

In this disclosure, the audio output apparatus 100 may update the background UI based on the selected item. For example, the audio output apparatus 100 may change an existing representative image on an existing background UI to a representative image corresponding to the selected item.

In this disclosure, the existing representative image may mean a representative image of an item selected (replayed) previously. Alternatively, the existing representative image may mean a representative image (e.g., an album art) of contents including a plurality of items.

The audio output apparatus 100 may display a screen in which the updated background UI is rotated. For example, the audio output apparatus 100 may display a screen in which the updated background UI is rotated with respect to an existing center point (the center point of an existing background UI).

At this time, the audio output apparatus 100 may display a screen in which the background UI is rotated in the state where a second UI is displayed on the background UI (an updated background UI). At this time, the audio output apparatus 100 may inactivate a plurality of first UIs displayed previously.

In this disclosure, the plurality of first UIs may mean UIs excluding a first UI corresponding to a selected item among a plurality of first UIs corresponding to a plurality of items respectively.

Then as specific time passes, the audio output apparatus 100 may inactivate a second UI.

As one example, as predetermined time passes after a display of the second UI, the audio output apparatus 100 may control the display 120 to inactivate the second UI and display a screen in which an updated background UI is rotated.

In this disclosure, the predetermined time may mean time set to maintain the state where a second UI is activated after activation of the second UI corresponding to the selected item. The predetermined time may be set based on the replay speed and replay length and the like of music, and may be set in various ways based on user settings.

For example in the case where the predetermined time is set to 2.5 seconds, the audio output apparatus 100 may inactivate the second UI as 2.5 seconds pass after the second UI is activated and displayed on the background UI. In this disclosure, the audio output apparatus 100 may decrease brightness gradually to inactivate the second UI or remove the second UI instantly to inactivate the second UI.

The audio output apparatus 100 may inactivate the second UI to display a screen in which the background UI is rotated.

For example, the audio output apparatus 100 may display the screen in which the background UI is rotated for predetermined time after the second UI is displayed, and as the predetermined time passes, inactivate the second UI and display the background UI that remains rotating.

However, inactivating the second UI and displaying the background UI is described merely as one example, and the audio output apparatus 100 may display the screen in which the background UI is rotated after the second UI is inactivated.

The audio output apparatus 100, as described above, may display a LP-shaped background UI, and as a specific item is selected, rotate the background UI, to provide, to the user, an experience in which the user feels like the user uses an actual LP. Additionally, the audio output apparatus 100 may update the background UI newly as a specific item is selected, to display the state where the specific item is being replayed effectively and intuitively.

In FIG. 2, the audio output apparatus 100 including basic elements only is illustrated, but may further include various elements in addition to the above elements.

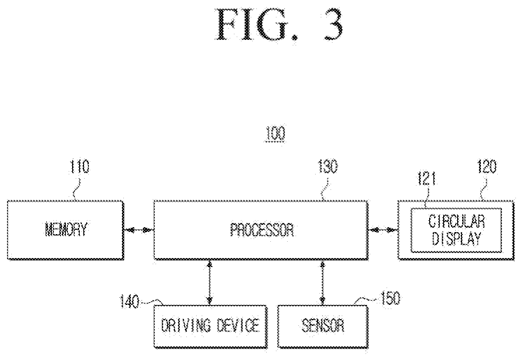

FIG. 3 is a detailed block diagram provided to explain a specific configuration of an audio output apparatus according to one or more embodiments.

Referring to FIG. 3, an audio output apparatus 100 may include memory 110, a display 120, at least one processor 130, a driving apparatus 140 and a sensor 150. In this disclosure, the display 120 may include a circular display 121.

The audio output apparatus 100, the memory 110, the display 120, and the at least one processor 130 are described above in detail with reference to FIG. 2, and accordingly, repetitive descriptions thereof are omitted in FIG. 3.

The circular display 121 may correspond to a display having a circle shape. The circular display 121 may correspond to an element optimal for the shapes of UIs and contents for the audio output apparatus 100 to display. For example, the audio output apparatus 100 may display UIs having a circle shape (a concentric circle shape) via the circular UIs through the circular display 121.

As one example, as a circular background UI is displayed in the state where a tonearm is placed in an initial position, the audio output apparatus 100 may control the circular display 121 to display a plurality of first UIs.

In this disclosure, the circular background UI may mean a UI having the above-described circle shape (a concentric circle shape). For example, the circular background UI may correspond to a UI formed into an actual LP and displayed through a screen.

The tonearm may correspond to an element that is rotatable with respect to an axis placed outside the display 120. In this disclosure, the tonearm may be rotated around a specific point in the outer region of the display 120, at the audio output apparatus 100.

As the tonearm is rotated as described above, a partial region of the tonearm may be placed on the circular display 121. In this disclosure, being placed on the circular display 121 may mean a state where the circular display 121 is covered, regardless of whether the partial region of the tonearm contacts the circular display or not.

For example, in the case where the circular display 121 is placed on the upper surface (a top face) of the audio output apparatus 100, the tonearm may be rotated around a specific point in a region excluding a region occupied by the circular display 121 on the upper surface. Additionally, the tonearm may be placed in the upper portion of the circular display 121 while rotating.

The state where the tonearm is placed in an initial position may be a state where the tonearm is in an initial position before rotating for the first time. For example, the initial position may correspond to a position at which part of the tonearm is not placed in the upper portion of the circular display 121.

The tonearm, as described above, may be used together with the circular display 121, and the audio output apparatus 100 may display a specific UI based on a specific position (or a rotation angle) of the tonearm.

As one example, the audio output apparatus 100 may control the display 120 to change a first UI to a second UI and display the second UI, based on a user manipulation for selecting one of a plurality of items corresponding to a plurality of positions respectively. In this disclosure, the plurality of positions may correspond respectively to positions to which the tonearm can be moved.

In detail, each of the plurality of items may be set to correspond to each of the plurality of positions to which the tonearm can be moved. In this disclosure, the plurality of positions to which the tonearm can be moved may be expressed as a plurality of angles at which the tonearm can be rotated. In this disclosure, the plurality of angles at which the tonearm can be rotated may mean a plurality of angles between an initial angle of the tonearm and a maximum angle of the tonearm.

In this disclosure, the maximum angle may be determined by at least one of the circular display and the background UI (a circular background UI). For example, the maximum angle may mean a maximum angle at which the tonearm is rotated from the initial angle to the degree that the tonearm does not go past an opposite point.

In this disclosure, the opposite point may mean an outer point rather than a point close to the initial position of the tonearm, among a plurality of positions that may be covered by the tonearm at the boundary of the circular display 121. The tonearm and the like are described above in detail with reference to FIG. 1, and accordingly, repetitive descriptions thereof are omitted.

The audio output apparatus 100 may set the plurality of items to correspond to the plurality of positions (angles) respectively, based on the maximum angle described above.

For example, in the case where four items (item A, item B, item C, and item D) are included in contents, the audio output apparatus 100 may set item A, item B, item C, and item D to correspond to a first angle, a second angle, a third angle, and fourth angle respectively, with respect to the initial position.

If the audio output apparatus 100 receives an input of a user manipulation for selecting a specific item (e.g., item B), the audio output apparatus 100 may move the tonearm at a corresponding angle (a second angle).

Alternatively, if the audio output apparatus 100 receives an input of a user manipulation using the tonearm, the audio output apparatus may display a UI based on an item corresponding to an angle at which the tonearm is moved. Detailed descriptions in relation to this are provided hereafter.

The driving apparatus 140 is an element for rotating the tonearm of the audio output apparatus 100. The driving apparatus 140 may rotate the tonearm at a specific angle based on a user manipulation input to the audio output apparatus 100. In this disclosure, the specific angle may correspond to an angle corresponding to a selected item.

The driving apparatus 140 rotating the tonearm at a specific angle may mean that the tonearm is moved in parallel with the upper portion of the display 120 or the circular display 121. Accordingly, the driving apparatus 140 may move the tonearm in the way that the tonearm is rotated such that part of the tonearm covers part of the display 120.

As one example, the audio output apparatus 100 may control the driving apparatus 140 such that the tonearm is moved to a position corresponding to a selected item among the plurality of positions, based on a user manipulation.

In this disclosure, the user manipulation may correspond to a manipulation for selecting a specific item. The position corresponding to a selected item may mean a position to which the tonearm is moved at an angle corresponding to a specific item selected.

For example, the audio output apparatus 100 may receive an input of a user manipulation for selecting item B among item A, item B, item C, and item D described above. In this case, the audio output apparatus 100 may receive an input of a user manipulation for selecting item B through a specific button (a button excluding a tonearm) or based on a touch input.

The audio output apparatus 100 may control the driving apparatus 140 such that the tonearm is moved at a second angle corresponding to item B, based on the user manipulation. Accordingly, the driving apparatus 140 may rotate the tonearm at the second angle from the initial position.

Thus, based on a user manipulation for selecting a specific item being present, the audio output apparatus 100 may move the tonearm to correspond to the user manipulation, such that the tonearm is placed in a portion corresponding to a specific track, as shown in an actual LP. Accordingly, the audio output apparatus 100 may provide, to the user, an experience in which the user feels like the user owns an actual LP.

Then the audio output apparatus 100 may control the circular display 121 to change a first UI to a second UI and display the second UI in the state where the tonearm is moved to the position. The operation in which the audio output apparatus 100 displays the second UI is described above in detail, and accordingly, repetitive descriptions thereof are omitted.

Meanwhile, in the case where the audio output apparatus 100 replays a following item after the replay state of the selected item ends, the audio output apparatus 100 may move the tonearm to a position corresponding to the following item. In detail, the audio output apparatus 100 may control the driving apparatus 140 to move the tonearm to a track region corresponding to the following item among a plurality of track regions (or arcs).

For example, in the case where item B is selected and replayed, the audio output apparatus 100 may move the tonearm to a position corresponding to item C as a replay of item B ends after replay time of item B passes. In other words, the audio output apparatus 100 may control the driving apparatus 140 such that the tonearm placed at the position corresponding to item B is rotated and placed at a position corresponding to item C.

In this disclosure, the plurality of track regions corresponding to the plurality of items (item A, item B, item C, and item D) respectively may be set from the outside to the inside. In other words, in the case where the plurality of items are set to be replayed in the order of item A, item B, item C, and item D, item A may be set to correspond to an outermost region, while item D may be set to correspond to an innermost region.

In this case, the audio output apparatus 100 may move the tonearm from the outside to the inside as the plurality of items are relayed sequentially. In detail, the audio output apparatus 100 may move the tonearm instantly to a position corresponding to a following item after existing items are all replayed.

However, the method by which the audio output apparatus 100 moves the tonearm is not limited thereto, and the audio output apparatus 100 may move the tonearm slowly in the process where a specific item is replayed. In this disclosure, moving the tonearm slowly may mean moving the tonearm at a predetermined speed.

In this disclosure, the predetermined speed may mean a speed determined based on replay time of a specific item and a width of a track region (or a gap among a plurality of arcs). In other words, the audio output apparatus 100 may set, as a movement speed of the tonearm, a value calculated by dividing the width of the track region corresponding to the specific item by an entire replay time (duration).

Accordingly, the audio output apparatus 100 may reflect a physical attribute of an actual LP more realistically. In this disclosure, the physical attribute of an actual LP may mean that the tonearm is moved slowly to the inside as music is replayed on an actual turntable. By doing so, the audio output apparatus 100 may maximize an experience in which the user feels like the user uses an actual LP.

The audio output apparatus 100 may include a sensor 150. The sensor 150 may sense movement of the elements of the audio output apparatus 100 and a surrounding environment of the audio output apparatus 100. For example, the sensor 150 may include an acceleration sensor, a gyroscope, an encoder, an ultrasonic sensor, an infrared sensor, a temperature sensor, a pressure sensor and the like.

In the case where the audio output apparatus 100 senses the movement of the elements of the audio output apparatus 100, the sensor may be implemented as an encoder. The encoder may sense a physical change in rotational or linear movement and convert the change into a digital signal. In this disclosure, the encoder may correspond to an optical encoder or a Hall Effect encoder.

The audio output apparatus 100 may sense movement of the tonearm through the sensor 150. As one example, the audio output apparatus 100 may sense rotation of the tonearm.

In this disclosure, the rotation of the tonearm may mean rotation based on a user manipulation. In other words, the rotation based on a user manipulation may correspond to rotation that may occur as the tone arm is rotated based on force applied by the user.

As one example, the audio output apparatus 100 may identify, as a selected item, an item of the position to which the tonearm is moved among a plurality of items, based on sensing data.

In this disclosure, the sensing data may correspond to data obtained based on sensing of rotation of the tonearm through the sensor 150. In this disclosure, the rotation of the tonearm may mean rotation based on a user manipulation.

For example, the audio output apparatus 100 may identify an angle at which the tonearm is moved based on the sensing data. In this disclosure, the audio output apparatus 100 may identify a change amount in angles based on an angle measurement value included in the sensing data.

The audio output apparatus 100 may identify an item of a position to which the tonearm is moved based on a change amount in angles. In this disclosure, the item of a position to which the tonearm is moved may mean an item corresponding to an angle after the tonearm is moved.

For example, if it is identified that the tonearm is moved from the initial position at a third angle, the audio output apparatus 100 may identify item C as the item of a position to which the tonearm is moved.

The audio output apparatus 100 may identify the item of the position to which the tonearm is moved as a selected item. For example, if the item of the position to which the tonearm is moved is item C, the audio output apparatus 100 may identify that item C is selected.

Then the audio output apparatus 100 may control the circular display to change a first UI corresponding to the selected item to a second UI and display the second UI. Herein the operation in which the audio output apparatus 100 displays the second UI is described above, and accordingly, repetitive descriptions thereof are omitted.

Accordingly, the audio output apparatus 100 may receive an input of a user manipulation through the tonearm. In other words, the user may directly manipulate the tonearm in a physical manner to select a specific item in the state where a plurality of first UIs is displayed on the circular display 121.

The audio output apparatus 100 may identify a degree to which the tonearm is moved based on the user manipulation, to identify that a specific item is selected and replay the selected item. By doing so, the audio output apparatus 100 may provide, to the user, a user experience in which the user feels like the user uses a LP through an actual turntable.

In FIG. 3, the audio output apparatus 100 including various additional elements is illustrated, but some of the illustrated elements may be omitted. Additionally, the audio output apparatus may further include other elements.

Hereafter, operations of the audio output apparatus 100 are described in greater detail with reference to FIGS. 4-10. Regarding FIGS. 4-10, individual embodiments are described for convenience of description. However, the individual embodiments in FIGS. 4-10 may be embodied in any possible combination.

FIG. 4 is a view provided to explain an operation of an audio output apparatus according to one or more embodiments.

FIG. 4 shows the operation in which the audio output apparatus 100 displays a plurality of first UIs 410, a selected item 411 and a second UI 412.

The audio output apparatus 100 may display the plurality of first UIs 410 on a background UI. The audio output apparatus 100 may display the plurality of first UIs 410, based on a user input for activating the plurality of first UIs 410 in an initial state or a replay state. In this disclosure, the initial state and replay state are described above in detail, and accordingly, repetitive descriptions thereof are omitted.

In the state where the plurality of first UIs 410 indicating a plurality of items respectively is displayed, the audio output apparatus 100 may receive an input of a user manipulation for selecting one of the plurality of items.

For example, in the state where a LP-shaped background UI is displayed, the audio output apparatus 100 may display a plurality of first UIs 410. In this disclosure, the plurality of first UIs 410 may include a plurality of contained tracks of a record album respectively. In this disclosure, the record album may correspond to a record album indicated by the background UI.

In this disclosure, each of the plurality of first UIs 410 may indicate the title and replay length of each of the plurality of contained tracks. The replay length of a first UI among the plurality of first UIs 410 may be expressed as a length of a curved line (an arc). Referring to the example of FIG. 4, the replay length of contained track No. 5 (05. If you love me) is longest.

Then the audio output apparatus 100 may receive an input of a user manipulation such as a touch manipulation and the like for selecting one (e.g., 05. If you love me) of the plurality of items.

The audio output apparatus 100 may display a second UI 412 with respect to a selected item 411 that is the one selected among the plurality of items. For example, in the case where the selected item 411 corresponds to contained track No. 5, the audio output apparatus 100 may change a first UI corresponding to contained track No. 5 to a second UI 412 and display the second UI 412.

In this disclosure, the second UI 412 may correspond to a UI of which brightness or thickness is changed from an existing first UI. In this disclosure, the existing first UI may correspond to a first UI corresponding to the selected item 411 among the plurality of first UIs 410.

In the state where the plurality of first UIs 410 is displayed on the background UI as described above, the audio output apparatus 100 may display the second UI 412 corresponding to the selected item 411 in the way that the second UI 412 is differentiated from the remaining first UIs. In this disclosure, the remaining first UIs may mean remaining first UIs excluding the first UI corresponding to the selected item 411 among the plurality of first UIs 410.

By doing so, the audio output apparatus 100 may allow the user to see the selected item 411 clearly among the plurality of items. Additionally, as the second UI 412 is displayed, the audio output apparatus 100 may display the background UI while rotating the background UI to provide, to the user, an experience in which the user feel like the user uses an actual LP.

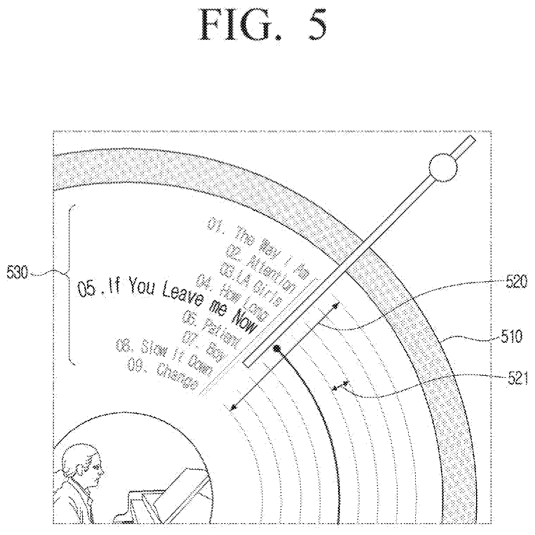

FIG. 5 is a view provided to explain a first UI according to one or more embodiments.

Referring to FIG. 5, a plurality of first UIs 530 displayed on a screen 510 is illustrated. In this disclosure, the plurality of first UIs 530 may be displayed with a regular gap 521 in a displayable region 520.

For example, the audio output apparatus 100 may display a LP record-shaped background UI, to display nine contained tracks. In this disclosure, the background UI may include a plurality of track regions divided through a plurality of arcs. In this disclosure, each of the track regions may correspond to each of the plurality of contained tracks.

The audio output apparatus 100 may display the plurality of first UIs 530 respectively along the plurality of arcs. In embodiments, the plurality of arcs may be disposed respectively with a regular gap 521. In embodiments, the regular gap 521 may be determined based on the displayable region 520 and the number of a plurality of items.

In this disclosure, the displayable region 520 may be included in a remaining region excluding a central representative image region, on the background UI.

In detail, the displayable region 520 may correspond to a region excluding a vacant region from the representative image region, in the above-described remaining region. In this disclosure, the vacant region, as a region having the same shape (a ring shape) as the track regions, may correspond to a region between the image region and the displayable region 520 in the background region. In this disclosure, the remaining region may also correspond to a region having the same shape as the track regions.

In this disclosure, the width of the representative image region or the vacant region may be determined based on user settings. In other words, the user may adjust the widths (sizes) of the representative image region and the vacant region, considering readability of the plurality of first UIs 530. However, the widths of the representative image region and the vacant region are not limited thereto, and the audio output apparatus 100 may determine the widths of the representative image region and the vacant region based on various factors such as a feature of a representative image, a feature of a record album, the number of a plurality of items and the like.

For example, in the case where a radius of the background UI corresponds to A, while a radius of the representative image region corresponds to B, the remaining region may correspond to a region having a width A-B. If the width of the vacant region is set to C, the width of the displayable region 520 may correspond to A-B-C.

The audio output apparatus 100 may determine the regular gap 521 based on the displayable regions 520 and the number of the plurality of items. For example, in the case where the number of the plurality of items is nine as described above, the regular gap 521 may be set to A-B-C/9.

The audio output apparatus 100 may display the plurality of first UIs 530 along the plurality of arcs disposed with the set regular gap 521.

For example, the audio output apparatus 100 may display the plurality of first UIs 530 such that a mean line of a text is placed at each of the plurality of arcs. In this disclosure, the mean line may mean a virtual reference line formed along the upper end of a x-height from small letters.

However, displaying the plurality of first UIs is not limited thereto, and the audio output apparatus 100 may display the first UIs 530 such that the plurality of first UIs 530 corresponds to the plurality of arcs respectively.

The audio output apparatus 100, as described above, may display the plurality of first UIs 530 along a plurality of virtual arcs disposed with a regular gap 521, such that the plurality of items are shown to the user in the way that spatial efficiency is ensured while readability of the plurality of items is enhanced.

FIG. 6 is a view provided to explain a user manipulation according to one or more embodiments.

Referring to FIG. 6, the operation in which a user manipulation 620 is input in the state where a plurality of first UIs 610 is displayed is illustrated.

In the state where the plurality of first UIs 610 is displayed, the audio output apparatus 100 may receive an input of a user manipulation 620 for selecting one of a plurality of items.

In this disclosure, the audio output apparatus 100 may display the plurality of first UIs 610 with a regular gap. In this disclosure, the regular gap may be determined based on the number of the plurality of items, as described above.

The regular gap may also be determined based on a minimum gap as well as the number of the plurality of items. For example, unlike the case in the example of FIG. 5, this case may correspond to a case where a regular gap determined based on the number of the plurality of items is less than or equal to a minimum gap.

In this disclosure, the minimum gap may mean a minimum gap for the user to recognize each of the plurality of items. In other words, in the case where the plurality of first UIs 610 is displayed along a plurality of arcs, a gap among the plurality of first UIs 610 may decrease as the number of the plurality of items increases. Accordingly, the size of each of the plurality of UIs (e.g., a font size) may decrease.

The minimum gap may be set such that the first UIs are displayed in a proper font size and with a proper gap based on user settings.

If the number of the plurality of items exceeds nine unlike the example of FIG. 5 (e.g., 12), a gap (e.g., A-B-C/12) determined based on the number of the items may be less than the minimum gap. In this case, the audio output apparatus 100 may set a gap greater than the minimum gap as a regular gap.

For example, the audio output apparatus 100 may display a maximum number of items. In this disclosure, the maximum number may mean the number of a plurality of items in the case of a regular gap greater than the minimum gap. In this disclosure, displaying a maximum number of items may mean that the audio output apparatus 100 displays a plurality of first UIs 610 corresponding to the maximum number of items respectively.

In the case where a value calculated by dividing the width of a displayable region by 11 is less than a minimum size (width) under the assumption that the number of a plurality of items is 11, the audio output apparatus 100 may identify the maximum number as nine that is a number when the width of the displayable region is greater than the minimum size. In this case, the audio output apparatus 100 may display nine items only. In other words, the audio output apparatus 100 may display nine first UIs corresponding to nine items respectively.

At this time, in the case where the audio output apparatus 100 displays only part of the plurality of items, the audio output apparatus may display a plurality of third UIs 630-1, 630-2, etc., displaying the presence of remaining items. In this disclosure, the plurality of third UIs 630-1, 630-2 may indicate that additional items are present in a corresponding direction.

The audio output apparatus 100 may identify that one of the plurality of items is selected based on a user manipulation 620. In this disclosure, the user manipulation 620 may include a manipulation for selecting remaining items excluding a plurality of displayed items.

In this disclosure, in the case where a gap based on the plurality of items (i.e., a value calculated by dividing a displayable region by the number of items) is greater than a minimum gap, the remaining items may mean items that are not displayed due to a limitation of the number of items. In this disclosure, the limitation of the number of items may mean a limitation of the number of a plurality of items that is displayable on the background UI.

In this case, the user may manipulate the audio output apparatus 100 to display the non-displayed items while moving the user's finger up and down. In the case where the non-displayed items are displayed, the user may perform a manipulation of selecting a non-displayed item.

Accordingly, the audio output apparatus 100 may allow part of the items to be covered such that a gap of an arc is greater than the minimum gap, while displaying the plurality of first UIs 610 along the plurality of arcs. In this case, the audio output apparatus 100 may display a cue indicating that remaining items are present on an additional UI (a plurality of third UIs 630-1, 630-2), to display a greater number of items effectively.

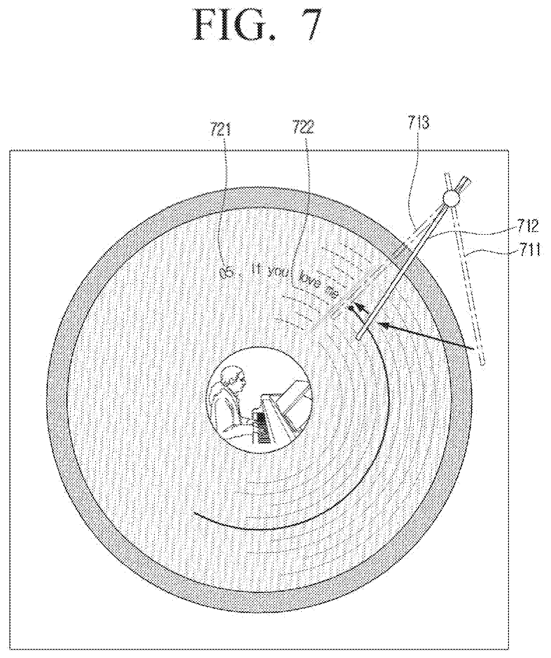

FIG. 7 is a view provided to explain a tonearm according to one or more embodiments.

Referring to FIG. 7, the operation in which the audio output apparatus 100 displays a second UI and the like based on a plurality of positions of a tonearm is illustrated.

The tonearm may be placed at an initial position 711, a first position 712 and a second position 713. In detail, the tonearm may be placed at the initial position 711, the first position 712 and the second position 713 respectively, based on a rotation angle.

For example, the tonearm may be rotated based on a user manipulation for manipulating the tonearm directly. Additionally, the tonearm may be rotated based on a user manipulation (e.g., a touch manipulation) excluding the user manipulation for manipulating the tonearm directly. Detailed descriptions in relation to this are provided above with reference to FIG. 3, and accordingly, repetitive descriptions thereof are omitted.

The tonearm, as described above, may be rotated (moved) depending on various cases, but hereafter, the tonearm being rotated based on a user manipulation for manipulating the tonearm directly is described as an example.

The tonearm (e.g., tonearm 10) may be placed at an initial position 711. In this disclosure, the initial position 711 may mean a state prior to an input of a user manipulation for selecting one of a plurality of items.

In the state where the tonearm is placed at the initial position 711, the audio output apparatus 100 may receive an input of a user manipulation for selecting one (e.g., 05. If you love me) of the plurality of items.

In this disclosure, the user manipulation may correspond to a manipulation of allowing the end portion of the tonearm to be placed at a position corresponding to a selected item 721 by rotating the tonearm. In this disclosure, the position corresponding to the selected item 721 may mean a position at which the end portion of the tonearm is placed on an arc corresponding to the selected item 721.

The audio output apparatus 100 may identify a first position 712 among a plurality of positions. In other words, the audio output apparatus 100 may identify a first position 712 corresponding to a user manipulation among a plurality of positions.

In detail, the audio output apparatus 100 may identify an angle corresponding to a user manipulation among a plurality of angles. In this disclosure, the plurality of angles may correspond to angles corresponding to the plurality of items respectively. The plurality of angles are described above in detail with reference to FIG. 2, and accordingly, repetitive descriptions thereof are omitted.

The audio output apparatus 100 may identify an item of the first position 712 corresponding to the identified angle as a selected item 721. The audio output apparatus 100 may display a second UI 722 corresponding to the selected item 721.

Meanwhile, after the selected item 721 is selected, the audio output apparatus 100 may receive an input of a user manipulation for changing to a new item. In this disclosure, the user manipulation may correspond to a manipulation of allowing the end portion of the tonearm to be placed at a position corresponding to the new item by rotating the tonearm additionally.

The audio output apparatus 100 may identify a second position 713 corresponding to a user manipulation. In detail, the audio output apparatus 100 may identify an angle corresponding to a user manipulation. The audio output apparatus 100 may identify an item corresponding to the identified angle, and identify the identified item as a newly selected item. Additionally, the audio output apparatus 100 may display a second UI corresponding to the newly selected item.

The audio output apparatus 100, as described above, may identify that a corresponding item among the plurality of items is selected, as the tonearm is moved from the initial position along the plurality of positions. Accordingly, the audio output apparatus 100 may replay and display contents in the same way as an actual tonearm and an actual LP are used to provide, to the user, an experience in which the user feels like the user uses an actual turntable.

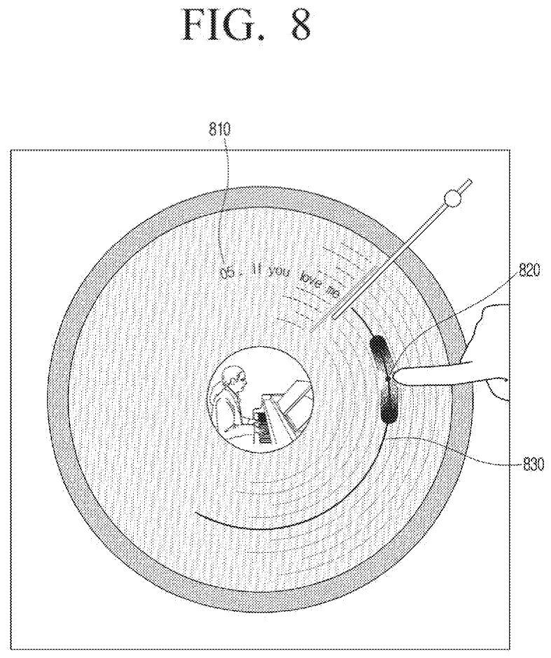

FIG. 8 is a view provided to explain a second UI according to one or more embodiments.

Referring to FIG. 8, the audio output apparatus 100 may adjust a replay position through a second UI 830 corresponding to a selected item 810.

The audio output apparatus 100 may display a second UI 830 including a progress bar shape, and display an indicator user interface (UI) 820 on the second UI 830.

In this disclosure, the progress bar may mean a linear-shaped graphic element indicating a progress state of a task or a progress rate of a replay medium visually. The indicator UI 820 may correspond to a graphic element (e.g., a point, a perpendicular line, an arrow and the like) emphasizing a current state or a specific point visually at the progress bar to indicate a progress state.

The audio output apparatus 100 may display a replay state on the second UI 830 through the indicator UI 820. For example, in the case where a selected item 810 is replayed, the audio output apparatus 100 may display the indicator UI 820 at a position corresponding to a current replay timepoint.

In the state where the replay state is displayed through the second UI 830, the audio output apparatus 100 may receive an input of a user manipulation for changing a replay state.

In this disclosure, the user manipulation for changing a replay state may correspond to a manipulation for changing a replay position (or timepoint) of a selected item 810. For example, the audio output apparatus 100 may receive an input of a touch manipulation for adjusting a replay position on the second UI 830 (e.g., the progress bar of the second UI 830).

In this disclosure, the touch manipulation may correspond to a drag manipulation for moving the indicator UI 820 along the second UI 830 (e.g., the progress bar of the second UI 830). However, the touch manipulation may not be limited thereto, and may correspond to a manipulation of tabbing a specific point of the second UI 830. Additionally, the touch manipulation may include a manipulation of dragging a remaining portion out of a background UI, and include various other types of manipulations.

In detail, the touch manipulation may correspond to a user manipulation for changing a replay state by using a plurality of fingers. In this disclosure, using a plurality of fingers may mean that two or more fingers move (rotate) together. In this disclosure, moving together may mean that two or more fingers rotate around the center of the background UI.

For example, in the state where three fingers (e.g., a thumb, an index finger, and a middle finger) contact a screen, the user may rotate the fingers around the center of the background UI. At this time, the user may rotate the three fingers such that the replay timepoint is moved to a desired replay position from a current replay position.

In this disclosure, the user may rotate the three fingers by a specific angle. In this disclosure, the specific angle may mean a central angle of a specific arc (an angle with respect to the center of a background UI). In this disclosure, the specific arc may mean an arc formed at the progress bar while the replay position is moved from an initial replay position to a desired replay position.

Based on sensing that the above-described user manipulation is input, the audio output apparatus 100 may recognize a rotation angle (a specific angle described above) corresponding to the user manipulation, and change the replay timepoint to a position corresponding to the rotation angle.

Meanwhile, based on the above-described user manipulation (a manipulation of rotating a plurality of fingers) being input, the audio output apparatus 100 may change the replay timepoint by a predetermined length of time from the current replay timepoint. For example, in the case where the user performs a manipulation of rotating three fingers, the audio output apparatus 100 may change the relay timepoint from the current replay timepoint to a timepoint that is ten seconds later, but not be limited thereto.

In the above descriptions, the manipulation for changing a replay state is described by using a touch input as an example, but not limited thereto, and the audio output apparatus 100 may receive an input of the above-described user manipulation through various other interfaces (an externa interface including a button and the like such as a tonearm).

The audio output apparatus 100, as described above, may display a replay state of a selected item 810 visually, and change the replay state of the selected item 810 based on a touch interaction. In particular, the audio output apparatus may display a replay state through the progress bar expressed as a length based on replay time more intuitively, and receive an input of a manipulation for changing a replay state, to provide, to the user, an experience in which the user feels like the user uses an actual LP.

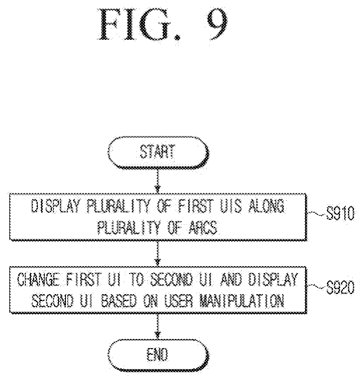

FIG. 9 is a view provided to explain a control method of an audio output apparatus according to one or more embodiments.

The audio output apparatus 100 may display a plurality of first UIs along a plurality of arcs (S910).

According to one or more embodiments, based on a background UI indicating a state of replaying contents being displayed, the audio output apparatus 100 may display the plurality of first UIs along the plurality of arcs dividing the background UI into a plurality of track regions.

According to one embodiment, the audio output apparatus 100 may display the plurality of first UIs along the plurality of arcs placed with a predetermined gap. In this disclosure, the predetermined gap may correspond to a gap determined based on the number of a plurality of items and the size of the background UI.

Then the audio output apparatus 100 may change a first UI to a second UI and display the second UI based on a user manipulation (S920).

According to one or more embodiments, the audio output apparatus 100 may change a first UI corresponding to a selected item among the plurality of first UIs displayed based on a user manipulation to a second UI corresponding to the selected item and display the second UI. In this disclosure, the user manipulation may correspond to a manipulation for selecting one of a plurality of items included in contents.

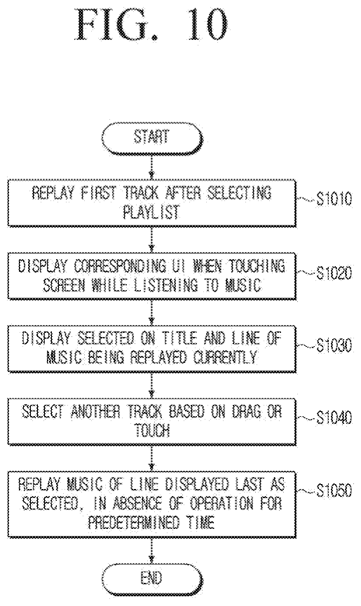

FIG. 10 is a flowchart provided to explain an operation of selecting and replaying a track according to one or more embodiments.

The audio output apparatus 100 may replay a first track after a playlist is selected (S1010). In this disclosure, the playlist may correspond to a list (contents) in which a plurality of tracks or media contents selected by the user are sorted out in a specific order or under specific conditions.

In this disclosure, the first track may mean a track set to be replayed first in a replay order in the playlist. For example, the track set to be relayed first may correspond to an outermost track region on an LP-shaped background UI.

In detail, the audio output apparatus 100 may set a track to be replayed first to correspond to an outermost track region (or an outermost arc), and a track to be relayed last to correspond to an innermost track region (or an innermost arc). In this disclosure, each track corresponding to each region may mean that a region (or an arc) where a first UI or a second UI is displayed is set for each track.

However, this is described merely as one example, and a track to be replayed first may be set to correspond to an innermost track region, while a track to be replayed last may be set to correspond to an outermost track region.

If the track to be replayed first corresponds to the outermost track region as described in the above-described example, the audio output apparatus 100 may display the background UI and the like by reflecting a physical attribute of an actual LP. In this disclosure, the physical attribute may mean that sound information corresponding to the first track in the outermost region on the actual LP is recorded through a groove. By doing so, the audio output apparatus 100 may enhance an experience in which the user feels like the use uses an actual LP, through a digital LP on which the above-described feature is reflected.

Then the audio output apparatus 100 may display a corresponding UI as a touch of a screen occurs while listening to music (S1020). In this disclosure, the touch of a screen occurring while listening to music may means that a user manipulation is input since the user touches the screen of the audio output apparatus 100 while the user listens to music.

In this disclosure, the corresponding UI may correspond to a background UI. For example, the audio output apparatus 100 may display a background UI corresponding to a selected playlist. In this disclosure, the background UI may include a representative image (e.g., an album art) of the selected playlist. Additionally, the audio output apparatus 100 may display a screen in which a circular background UI is rotated while replaying the first track.

Then the audio output apparatus 100 may display “selected” at the title and line of the music currently being replayed (S1030). For example, the audio output apparatus 100 may display “selected” beside the title or on the line. In this disclosure, the line may mean a progress bar of the selected track.

In this case, the audio output apparatus 100 may display a plurality of remaining first UIs of plurality of tracks excluding the track currently being replayed. In this disclosure, the plurality of remaining first UIs may mean first UIs excluding the first UI corresponding to the selected track among the plurality of first UIs.

Then the audio output apparatus 100 may select another track based on a drag or a touch (S1040). In this disclosure, the drag or touch may correspond to a user manipulation for selecting a track different from the track being replayed. However, the user manipulation for selecting a track is not limited to the above example, and the user manipulation may correspond to a manipulation through another button such as a tonearm and the like.

In the case where the audio output apparatus 100 receives an input of a user manipulation based on a drag, the user manipulation may correspond to a manipulation of moving, to a new position, a living body (e.g., a finger) in contact with the screen, in the state of touching a region in which the second UI is displayed. In this disclosure, the new position may mean a position at which a first UI of another track (a track (to be) selected newly) is displayed.

In the case where the audio output apparatus 100 receives an input of a user manipulation based on a touch, the user manipulation may correspond to a manipulation of tabbing (or double-tabbing) a first UI corresponding to another track in the state where “selected” is displayed on the track being replayed.

Then the audio output apparatus 100 may replay a track of a line selected (displayed) last in the case where an operation is absent for predetermined time (S1050). In this disclosure, the operation may mean a user manipulation for selecting a new track. The predetermined time may mean time (a duration) allowed for the audio output apparatus 100 to receive an input of the user manipulation for selecting a new track.

The track of the line selected last may mean a track displayed on the line (arc) selected last. In other words, the track of the line selected last may mean a track displayed on the selected line through the second UI.

For example, the audio output apparatus 100 may receive an input of a user manipulation for predetermined time after a previously selected track is replayed. In the case where the user manipulation is not input for the predetermined time, the audio output apparatus 100 may continue to replay the previously selected track and inactivate a displayed UI.

In this disclosure, the previously selected track may mean a track selected based on a previous user manipulation or a track replayed for the first time. In this disclosure, the track replayed for the first time may mean a track set to be replayed for the first time (automatically) among a plurality of tracks.

The audio output apparatus 100 inactivating a displayed UI may mean removing remaining UIs (a first UI and a second UI and the like) excluding the background UI. For example, as predetermined time passes, the audio output apparatus 100 may display a screen in which the background UI is rotated while maintaining a replay state of an existing track.

Meanwhile, in the case where the replay state of the existing track continues and then the existing track is replayed completely (i.e., in the case where a replay time passes), the audio output apparatus 100 may relay a following track. In this disclosure, the following track may mean a track set to be replayed following the existing track in a replay order.

For example, a track region (or arc) corresponding to the following track may be adjacent to a track region (or arc) corresponding to the existing track. In other words, in the case where each of a plurality of tracks corresponds to each of a plurality of track regions, the audio output apparatus 100 may replay a track corresponding to a following region in succession, in a predetermined replay order. As the replay state of the following track ends, the audio output apparatus 100 may replay a track corresponding to a following region in succession.

By doing so, the audio output apparatus 100 may replay a plurality of tracks in accordance with a physical attribute of an actual LP. In this disclosure, the physical attribute may mean an attribute of an order (from the outside to the inside) of a position at which a plurality of tracks is recorded on an actual LP. Accordingly, the audio output apparatus 100 may enhance an experience in which the user feels like the user uses an actual LP.

As described above, the audio output apparatus 100 may display a plurality of first UIs, based on a user manipulation for displaying a plurality of tracks, even in the state where a tracks is being replayed. Then as a new track is selected, the audio output apparatus may display a screen indicating a replay state of the new track, and in the absence of an operation for predetermined time, may display a screen indication an existing replay state.

By doing so, the audio output apparatus 100 may display a plurality of selectable first UIs to receive an input of a user manipulation in the case where a replay state needs to be changed (e.g., a case where another track needs to be selected and the like).

Accordingly, the audio output apparatus 100 may display a background UI of an actual LP shape only in the case where the relay state continues, to provide a visual effect of replaying music through an actual LP. Additionally, the audio output apparatus 100 may display each contained track by reflecting a physical attribute of an actual LP, enhancing an experience in which an actual LP is used through a turntable.

Meanwhile, in FIGS. 9 and 10, the order of all the steps is mapped for convenience of description, but certainly, an order of steps and the like performable regardless of order or in parallel is not limited to the mapped order.

The methods according to at least part of the embodiments described above may be implemented in the form of an application installable in an existing audio output apparatus.

Additionally, the methods according to at least part of the embodiments described above may be implemented only with a software upgrade, or a hardware upgrade of an existing audio output apparatus.

Further, the methods according to at least part of the embodiments described above may also be performed through an embedded server provided in an audio output apparatus or an external server of at least one among audio output apparatuses.

The embodiments described above may be implemented with software including instructions stored in a storage medium readable by a machine (e.g., a computer). The machine, as an apparatus capable of calling the stored instructions from the storage medium and operating according to the called instructions, may include an audio output apparatus (e.g., an audio output apparatus 100) according to the disclosed embodiments. Based on instructions being executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. In this disclosure, the “non-transitory storage medium” only means that the storage medium is tangible and includes no signal (e.g., an electromagnetic wave), while the term does not differentiate semi-permanent or temporary storage of data in the storage medium. For example, the “non-transitory storage medium” may include a buffer in which data are temporarily stored. The method according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed (e.g., downloaded or uploaded) online through an application store (e.g., Play Store™) or directly between two user apparatuses (e.g., smartphones). In the case of online distribution, at least part of the computer program product (e.g., a downloadable app) may be stored at least temporarily, or generated temporarily in a machine-readable storage medium such as a manufacturer's server, a server of an application store, or memory of a relay server.

The embodiments set forth herein may be implemented with software including instructions stored in a storage medium readable by a machine (e.g., a computer). The machine, as an apparatus capable of calling the stored instructions from the storage medium and operating according to the called instructions, may include the audio output apparatus (e.g., an audio output apparatus 100) according to the disclosed embodiments.

Based on the above-described instructions being executed by a processor, the processor may perform functions corresponding to the instructions directly or by using other elements under the control of the processor. The instructions may include a code generated or executed by a compiler or an interpreter.

While example embodiments of the disclosure have been illustrated and described above, embodiments of the disclosure are not limited to the embodiments set forth in this disclosure, and certainly, various modifications thereof may be made by those skilled in the art to which the disclosure pertains, without departing from the scope of the subject matter of the disclosure claimed in the section of claims, and are not to be understood as separating from the technical spirit or prospect of the disclosure.

What is claimed is:

1. An audio output apparatus comprising:
memory storing instructions;
a display; and
at least one processor including processing circuitry,
wherein the instructions, when executed by the at least one processor individually or collectively, cause the audio output apparatus to:
control, based on a background user interface (UI) indicating a state of replaying contents being displayed, display a plurality of first UIs along a plurality of arcs that divide the background UI into a plurality of track regions; and
control, based on a user manipulation for selecting an item of a plurality of items included in the contents, the display to change a first UI corresponding to the item among the plurality of displayed first UIs to a second UI corresponding to the item, and display the second UI.

2. The audio output apparatus of claim 1, wherein the plurality of arcs are spaced apart from each other by a predetermined gap based on a number of the plurality of items and a size of the background UI.

3. The audio output apparatus of claim 1, wherein the instructions, when executed by the at least one processor individually or collectively, cause the audio output apparatus to:
control the display to display the plurality of first UIs along the plurality of arcs based on a first user manipulation for activating the plurality of first UIs; and
control the display to change the first UI to the second UI and display the second UI based on a second user manipulation for selecting the item of the plurality of items.

4. The audio output apparatus of claim 1, wherein the instructions, when executed by the at least one processor individually or collectively, cause the audio output apparatus to:
inactivate, based on a user manipulation for selecting a second item different from a first item selected previously among the plurality of items, the second UI corresponding to the first item; and
control the display to change a first UI corresponding to the second item along an arc corresponding to the second item among the plurality of arcs to a second UI corresponding to the second item and display the second UI.

5. The audio output apparatus of claim 4, wherein the instructions, when executed by the at least one processor individually or collectively, cause the audio output apparatus to:
control the display to change at least one first UI corresponding to at least one third item between the second item and the first item respectively to at least one second UI corresponding to the at least one third item and display the at least one second UI sequentially; and
control the display to change the first UI corresponding to the second item to the second UI corresponding to the second item and display the second UI.

6. The audio output apparatus of claim 1, wherein the instructions, when executed by the at least one processor individually or collectively, cause the audio output apparatus to:
control the display to change the first UI to the second UI and display the second UI, based on a user manipulation for selecting the item to be replayable at the audio output apparatus; and
control the display to display a screen in which the background UI updated based on the item is rotated with respect to a center point of the background UI.

7. The audio output apparatus of claim 6, wherein the instructions, when executed by the at least one processor individually or collectively, cause the audio output apparatus to control the display to inactivate the second UI, as predetermined time passes after the second UI is displayed, and display the screen in which the updated background UI is rotated.

8. The audio output apparatus of claim 1 further comprising:
a tonearm rotatable with respect to an axis placed outside the display,
wherein the display is a circular display, and
wherein the instructions, when executed by the at least one processor individually or collectively, cause the audio output apparatus to:
control, based on a circular background UI being displayed in a state in which the tonearm is placed at an initial position, the circular display to display the plurality of first UIs; and
control the display to change the first UI to the second UI and display the second UI, based on the user manipulation for selecting the item of the plurality of items corresponding respectively to a plurality of positions to which the tonearm is capable of being moved.

9. The audio output apparatus of claim 8 further comprising:
a driving apparatus configured to rotate the tonearm,
wherein the instructions, when executed by the at least one processor individually or collectively, cause the audio output apparatus to:
control the driving apparatus to move the tonearm to a position corresponding to the item among the plurality of positions, based on the user manipulation; and
control the circular display to change the first UI to the second UI and display the second UI in a state in which the tonearm is moved to the position.

10. The audio output apparatus of claim 8 further comprising:
a sensor configured to sense rotation of the tonearm,
wherein the instructions, when executed by the at least one processor individually or collectively, cause the audio output apparatus to:
identify, as the item, an item of a position to which the tonearm is moved among the plurality of items, based on sensing data obtained by sensing the rotation of the tonearm, wherein the rotation of the tonearm is sensed based on the user manipulation through the sensor; and
control the circular display to change the first UI corresponding to the item to the second UI and display the second UI.

11. A control method of an audio output apparatus, the control method comprising:
displaying, based on a background user interface (UI) indicating a state of replaying contents being displayed by a display of the audio output apparatus, a plurality of first UIs along a plurality of arcs that divides the background UI into a plurality of track regions; and
changing, based on a user manipulation selecting an item of a plurality of items included in the contents, a first UI corresponding to the item among the plurality of displayed first UIs to a second UI corresponding to the item, and displaying the second UI.

12. The control method of claim 11, wherein the plurality of arcs are spaced apart from each other by a predetermined gap based on a number of the plurality of items and a size of the background UI.

13. The control method of claim 11, wherein the displaying the plurality of first UIs comprises displaying the plurality of first UIs along the plurality of arcs based on a first user manipulation for activating the plurality of first UIs, and
wherein the changing a first UI to a second UI and the displaying the second UI comprises changing the first UI to the second UI and displaying the second UI based on a second user manipulation for selecting the item of the plurality of items.

14. The control method of claim 11, wherein the changing the first UI to the second UI and displaying the second UI comprises:
inactivating, based on the user manipulation for selecting a second item different from a first item selected previously among the plurality of items, the second UI corresponding to the first item; and
changing a first UI corresponding to the second item along an arc corresponding to the second item among the plurality of arcs to a second UI corresponding to the second item and displaying the second UI.

15. The control method of claim 14, wherein the changing the first UI corresponding to the second item along the arc corresponding to the second item among the plurality of arcs to the second UI corresponding to the second item and the displaying the second UI comprises:
changing at least one first UI corresponding to at least one third item between the second item and the first item respectively to at least one second UI corresponding to the at least one third item and displaying the at least one second UI sequentially; and
changing the first UI corresponding to the second item to the second UI corresponding to the second item and displaying the second UI.

16. The control method of claim 11, wherein the changing the first UI corresponding to the selected item to the second UI corresponding to the selected item and displaying the second UI comprises changing the first UI to the second UI and displaying the second UI, based on a user manipulation for selecting the item to be replayable at the audio output apparatus, and
wherein the control method further comprises displaying a screen in which the background UI updated based on the item is rotated with respect to a center point of the background UI.

17. The control method of claim 16, wherein the displaying the screen in which the updated background UI is rotated with respect to the center point of the background UI comprises inactivating the second UI, as predetermined time passes after the second UI is displayed, and displaying the screen in which the updated background UI is rotated.

18. The control method of claim 11, wherein the display is a circular display, and
wherein the displaying the plurality of first UIs comprises:
controlling, based on a circular background UI being displayed in a state in which a tonearm rotatable with respect to an axis placed outside the circular display at the audio output apparatus is placed at an initial position, the circular display to display the plurality of first UIs, and
wherein the displaying the first UI corresponding to the item to the second UI corresponding to the item and displaying the second UI comprises controlling the circular display to change the first UI to the second UI and display the second UI, based on the user manipulation for selecting the item of the plurality of items corresponding respectively to a plurality of positions to which the tonearm is capable of being moved.

19. The control method of claim 18, wherein the controlling the circular display to change the first UI to the second UI and display the second UI comprises:
controlling a driving apparatus of the audio output apparatus to move the tonearm to a position corresponding to the item among the plurality of positions, based on the user manipulation; and
controlling the circular display to change the first UI to the second UI and display the second UI in a state where the tonearm is moved to the position.

20. A non-transitory computer-readable recording medium storing instructions that, when executed by at least one processor of an audio output apparatus, collectively or individually, cause the audio output apparatus to perform operations comprising:
generating a screen in which a plurality of first user interfaces (UIs) is displayed along a plurality of arcs that divide a background UI indicating a state of replaying contents into a plurality of track regions; and
generating, based on a user manipulation for selecting an item of a plurality of items included in the contents, a screen in which a first UI corresponding to the item among the plurality of displayed first UIs is changed to a second UI corresponding to the item.
